(19) United States
(12) Patent Application Publication
(10) Pub. No.: US 2018/0156256 A1
(43) Pub. Date: Jun. 7, 2018

(54) FASTENING PART AND METHOD FOR FORMING FASTENING PART

(71) Applicant: NEC Corporation, Minato-ku, Tokyo (JP)

(72) Inventor: Kenji OKUMURA, Tokyo (JP)

(73) Assignee: NEC Corporation, Minato-ku, Tokyo (JP)

(21) Appl. No.: 15/576,933

(22) PCT Filed: May 23, 2016
(86) PCT No.: PCT/JP2016/002482

§ 371 Date: Nov. 27, 2017

(30) Foreign Application Priority Data
May 29, 2015 (JP) 2015-109942

(51) Int. Cl. F16B 21/08; F16B 5/06

(52) U.S. Cl. CPC F16B 21/08; F16B 5/0642

(57) ABSTRACT

A fastening part 1 has a pin body 3 that is inserted in a through hole formed in a member of an object to be installed. The pin body 3 has elastic sections 12A, 12B and locking parts 14A, 14B that form pairs. The elastic sections 12A, 12B extend along the direction of insertion in the through hole of the object into which the elastic sections are to be inserted, and the distal ends that serve as the leading ends when inserted in said through hole form free ends and are capable of elastic deformation. The locking parts 14A, 14B protrude in mutually opposite directions from the free ends of the respective elastic sections 12A, 12B in directions that intersect with the direction of flexural displacement of the free ends of said elastic sections 12A, 12B that results from elastic deformation of the elastic sections 12A, 12B.

### TECHNICAL FIELD

The present invention relates to a part that makes fastening between constituent members constituting a device, for example.

### BACKGROUND ART

For example, in order to cool a heat generation part such as a semiconductor element installed in a circuit board, a heat sink is sometimes attached to the circuit board. Various structures have been proposed as a structure of attaching a heat sink to a circuit board. PTL 1 discloses one of the proposals. In PTL 1, a heat sink is attached to a circuit board by using the following fastening part (a push pin). Specifically, FIG. 10 is a diagram schematically illustrating the fastening part disclosed in PTL 1.

In an example of FIG. 10, a heat sink 100 is attached to a circuit board 101 by a fastening part 104, in a state of being arranged on an upper side of a heat generation part (e.g., a semiconductor element) 102 installed on a board surface of the circuit board 101. Through holes 106 and 107 through which the fastening part 104 is inserted are formed at the heat sink 100 and the circuit board 101.

The fastening part 104 includes a shaft body 110 that can be inserted through the through holes 106 and 107. A one-end side of the shaft body 110 is a distal end portion 111 which serves as a leading end when the shaft body 110 is inserted into the through holes 106 and 107, and has a tapered shape becoming thinner toward a distal end in order to be easily inserted into the through holes 106 and 107. A collar portion 112 is formed on the other end side of the shaft body 110.

Further, a locking portion 113 is formed in the shaft body 110, at a portion that protrudes from the circuit board 101 toward a lower side of FIG. 10 when the shaft body 110 is inserted through the through hole 107 of the circuit board 101. The locking portion 113 includes a plurality of elastic pieces 114. These elastic pieces 114 extend in a direction along an axis of the shaft body 110, form free ends on sides of extending distal ends, and form fixed ends on sides of proximal ends. The extending distal end side of the elastic piece 114 can elastically deform, with the proximal end side functioning as a base point, in a direction getting away from and closer to the axis of the shaft body 110. In this example, when pressing force does not act on the elastic pieces 114, the elastic pieces 114 are in an opening state as in FIG. 10. Pressing force acting on the elastic pieces 114 in directions toward the axis of the shaft body 110 causes the free end sides of the elastic pieces 114 to elastically deform in the acting directions of the pressing force so that the elastic pieces 114 are put in a closed state.

Closing the elastic pieces 114 enables the locking portion 113 to be inserted through the through holes 106 and 107. At the locking portion 113 that has passed through the through holes 106 and 107, the elastic pieces 114 are opened, and thereby, the extending distal ends of the elastic pieces 114 are locked on an opening edge of the through hole 107 in the circuit board 101. Accordingly, the fastening part 104 is prevented from falling out of the through holes 106 and 107 (prevented from slipping off).

The shaft body 110 is fitted, on a side of the collar portion 112 thereof, into a coil-shaped spring 115. The spring 115 is arranged in a compressed state between the collar portion 112 and an opening edge portion of the through hole 106 of the heat sink 100, and gives biasing force to the collar portion 112 and the heat sink 100. The biasing force of this spring 115, and pressing force based on the biasing force and directed from the locking portion 113 to the circuit board 101 fix the fastening part 104 to the circuit board 101 and the heat sink 100.

### CITATION LIST

### Patent Literature

[PTL 1] Japanese Laid-open Patent Publication No. 2014-183258

### SUMMARY OF INVENTION

### Technical Problem

In the fastening part 104 illustrated in FIG. 10, the elastic pieces 114 of the locking portion 113 need to have sizes enabling elastic deformation and pressing against the circuit board 101 by force that can prevent slip-off of the fastening part 104. For this reason, there is a problem that it is difficult to reduce a size of the fastening part 104.

Further, when the shaft body 110 of the fastening part 104 is inserted through the through holes 106 and 107, the shaft body 110 needs to be pushed into the through holes 106 and 107 by large pushing force elastically deforming a plurality of the elastic pieces 114. There is a possibility that an impact caused by the pushing force is applied to the heat sink 100 and the circuit board 101 to thereby adversely influence the heat sink 100 and the circuit board 101.

In order to solve the above-described problem, the present invention has been conceived. In other words, a main object of the present invention is to provide a technique of a fastening part that can be easily attached to an attaching-target member, and can further achieve improvement in reliability of slip-off prevention and downsize the part.

### Solution to Problem

A fastening part of the present invention includes a pin body that is inserted through a through hole formed in an attaching-target member.

The pin body includes:

elastically-deformable elastic sections that make a pair, each of the elastic sections extending along a direction of being inserted into the through hole and having a free end which is on side of distal end serving as leading end when being inserted into the through hole; and

locking portions that project from each side of free end of the elastic section and protrude in directions opposite to each other, projection directions of the locking portions being directions crossing to directions in which free ends of the elastic sections move due to elastic deformation of the elastic sections.

The elastic sections elastically deform in such a way that the locking portions are displaced in the directions opposite to the projection directions, thereby the pin body is enabled to be inserted into the through hole, and the locking portions are locked on an opening edge of the through hole through which the pin body is inserted, thereby the pin body is prevented from slipping out of the through hole.

A method for forming a fastening part of the present invention, includes:

forming, in a pin body that is inserted through a through hole formed in an attaching-target member, elastically-deformable elastic sections that make a pair, each of the elastic sections extending along a direction of being inserted into the through hole and having a free end which is on side of distal end serving as leading end when being inserted into the through hole; and

further forming, in the pin body, locking portions that project from each side of free end of the elastic section and protrude in directions opposite to each other, projection directions of the locking portions being directions crossing to directions in which free ends of the elastic sections move due to elastic deformation of the elastic sections.

### Advantageous Effects of Invention

According to the present invention, it is possible to provide a fastening part that can be easily attached to an attaching-target member, and can further achieve improvement in reliability of slip-off prevention and downsize the part.

### BRIEF DESCRIPTION OF DRAWINGS

FIG. 1 is a three-plane view illustrating a fastening part of a first example embodiment according to the present invention.

FIG. 2 is a schematic, perspective view illustrating the fastening part according to the first example embodiment.

FIG. 3 is a diagram illustrating the fastening part according to the first example embodiment.

FIG. 4 is a diagram illustrating locking portions of elastic sections in the fastening part according to the first example embodiment.

FIG. 5 is a diagram further illustrating the locking portions of the elastic sections in the fastening part according to the first example embodiment.

FIG. 6 is a diagram still further illustrating the locking portions of the elastic sections in the fastening part according to the first example embodiment.

FIG. 7 is a diagram illustrating one example of a used state of the fastening part according to the first example embodiment.

FIG. 8 is a diagram further illustrating the used state of the fastening part in FIG. 7.

FIG. 9 is a three-plane view illustrating a fastening part of a second example embodiment according to the present invention.

FIG. 10 is a diagram illustrating a configuration of a fastening part in the PTL 1.

### DESCRIPTION OF EMBODIMENTS

The following describes example embodiments according to the present invention, with reference to the drawings.

### First Example Embodiment

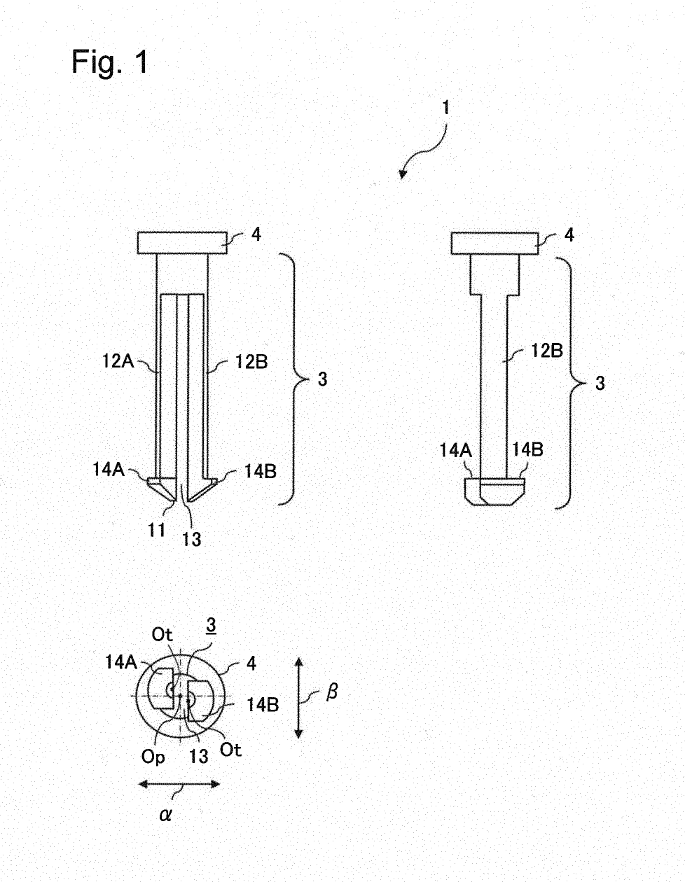

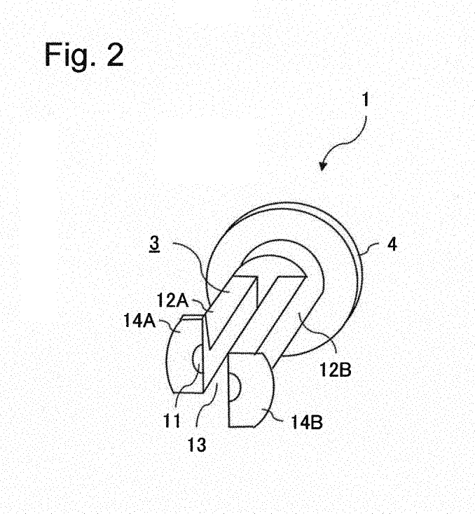

FIG. 1 is a three-plane view schematically illustrating a fastening part of a first example embodiment according to the present invention. FIG. 2 is a perspective view of the fastening part according to the first example embodiment in FIG. 1, seen from a lower side in FIG. 1. A fastening part 1 according to the first example embodiment includes a pin body 3 and a collar portion 4.

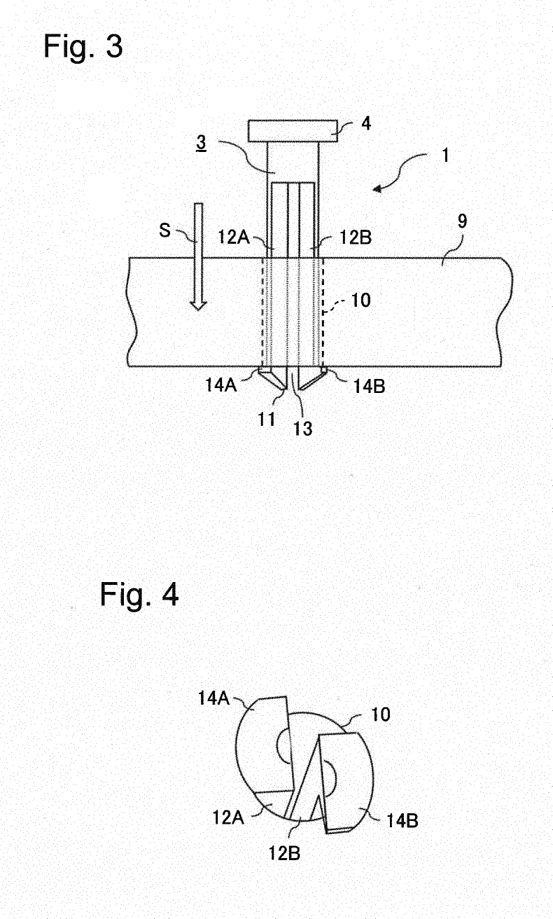

The pin body 3 is a section that is inserted through a through hole 10 formed in an attaching-target member 9, as illustrated in FIG. 3. Formed in this pin body 3 is a gap (a slit) 13 extending in a direction along an insertion direction S, from a distal end portion 11 serving as a leading end at the time of being inserted into the through hole 10. In the pin body 3, the gap 13 forms elastic sections 12A and 12B arranged next to each other via the gap 13 and making a pair. These elastic sections 12A and 12B form free ends on distal end sides and can elastically deform. In the first example embodiment, displacing directions at the free ends of the elastic sections 12A and 12B by elastic deformation are directions α (refer to FIG. 1) getting away from and closer to the gap 13. The elastic sections 12A and 12B illustrated in FIG. 1, FIG. 2, and FIG. 3 are in a state of being not elastically deformed.

Provided on the free-end sides (distal-end sides) in the respective elastic sections 12A and 12B are locking portions 14A and 14B that protrude outward from the elastic sections 12A and 12B. Here, as illustrated in FIG. 1, directions in which the free ends of the elastic sections 12A and 12B are displaced by bending the elastic sections 12A and 12B are assumed to be the directions α, and directions perpendicular to the directions α are assumed to be directions β. Although the locking portions 14A and 14B are shaped to be displaced in approximately line-symmetric with respect to the gap 13, the locking portions 14A and 14B are arranged to be directed oppositely from each other in the directions β in a state where the elastic sections 12A and 12B are not elastically deformed. In this state, as illustrated in FIG. 3 and FIG. 4, the locking portions 14A and 14B are locked on an opening edge of the through hole 10 through which the pin body 3 is inserted.

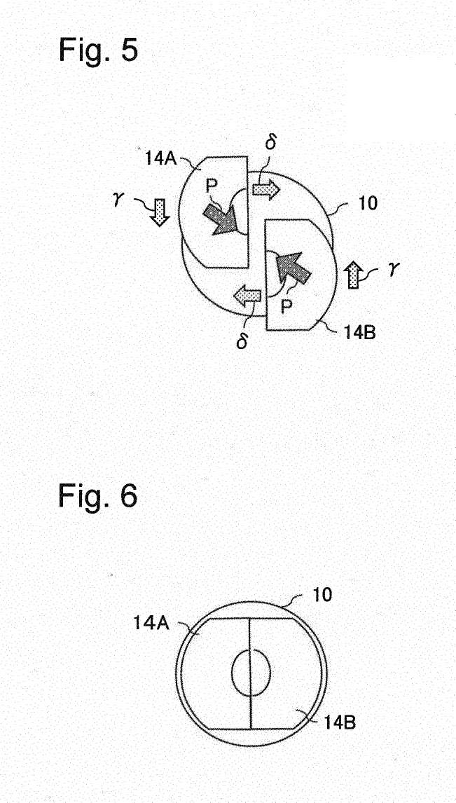

The elastic sections 12A and 12B are designed to elastically deform in such a way to narrow the gap 13 and cancel displacing amount between the locking portions 14A and 14B in the directions β in order that the locking portions 14A and 14B can be put in an aligned state as illustrated in a plan view of FIG. 6. In other words, as illustrated in a model diagram of FIG. 5, the elastic sections 12A and 12B are elastically deformable in γ directions of canceling the displacing amount between the locking portions 14A and 14B in the directions β and elastically deformable in δ directions of narrowing the gap 13 (i.e., in P directions) in order that the locking portions 14A and 14B can be put in the aligned state. In such an aligned state, the locking portions 14A and 14B are enabled to be inserted through the through hole 10 as illustrated in the plan view of FIG. 6.

Sizes and shapes of the locking portions 14A and 14B are designed by taking into account a size and a shape of the through hole 10, in such a way that the locking portions 14A and 14B can be locked on the opening edge of the through hole 10 as described above and be inserted through the through hole 10.

Distal end faces of the elastic sections 12A and 12B are formed into tapered faces provided with inclined portions. In the first example embodiment, the tapered faces are formed into curved faces of conic-surface shapes. As illustrated in FIG. 1, conic-vertex positions Ot of the tapered faces are displaced from a center axis Op of the pin body 3.

In the first example embodiment, the tapered faces are inclined portions that guide elastic deformation of the elastic sections 12A and 12B when the pin body 3 is inserted into the through hole 10. In other words, the tapered faces are provided with the inclined portions that can receive pressing force of the P directions illustrated in FIG. 5 while sliding on the opening edge of the through hole 10. For this reason, the tapered faces can guide elastic deformation of the elastic sections 12A and 12B in order to enable the locking portions 14A and 14B to be inserted into the through hole 10.

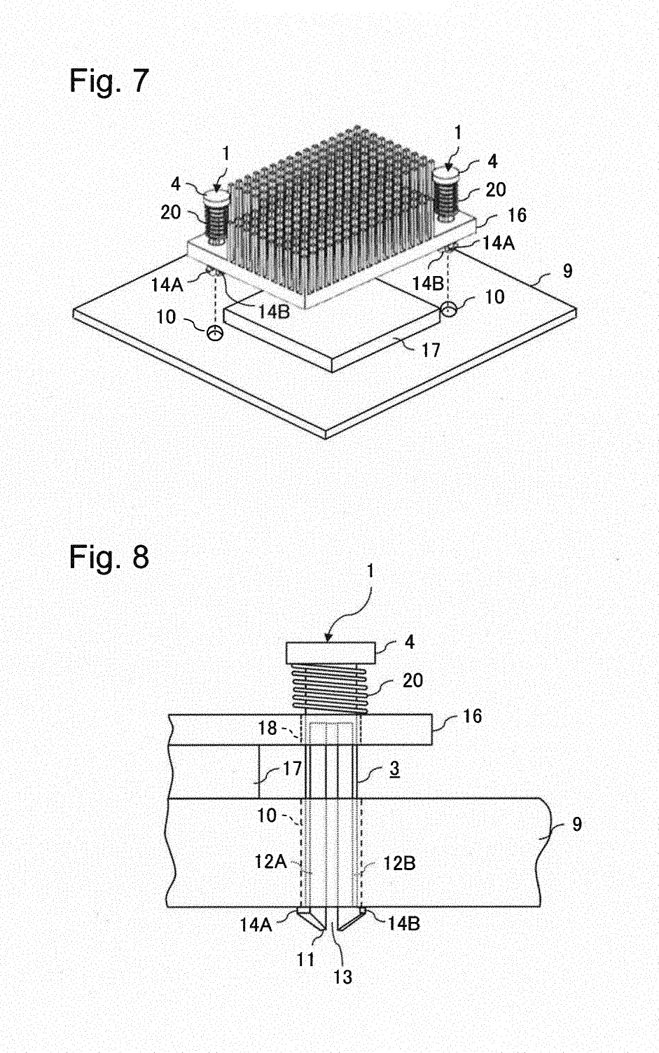

FIG. 7 is a model diagram illustrating a configuration example in which a heat sink 16 is installed in a circuit board 9 as the attaching-target member by using the fastening part 1 according to the first example embodiment. FIG. 8 is a side view schematically illustrating the fastening part 1 that has the heat sink 16 attached to the circuit board 9. In the example of FIG. 7 and FIG. 8, a heat generation part (e.g., a semiconductor element) 17 is installed on the circuit board 9, and the heat sink 16 is arranged in the circuit board 9, in a state of holding the heat generation part 17 between itself and the circuit board 9. Formed respectively in the circuit board 9 and the heat sink 16 are through holes 10 and 18 through which the pin body 3 of the fastening part 1 is inserted. When the heat sink 16 is arranged in the circuit board 9, alignment is made in such a way that center axes of the through holes 10 and 18 are coaxial with each other.

The pin body 3 in a state where a coil-shaped spring 20 as an elastic member is attached thereto is inserted, from the distal end portion 11, through the through hole 18 of the heat sink 16 and the through hole 10 of the circuit board 9 in order. At this time, because of sliding between the tapered faces at the distal end of the pin body 3 and the opening edges of the through holes 10 and 18, a pressing force P as illustrated in FIG. 5 deforms the elastic sections 12A and 12B elastically, and thereby puts the locking portions 14A and 14B in the aligned state as in FIG. 6. Accordingly, the pin body 3 can be inserted through the through holes 10 and 18. When the locking portions 14A and 14B of the pin body 3 pass through the through holes 10 and 18, and the pressing force ceases acting on the elastic sections 12A and 12B, the locking portions 14A and 14B are locked on the opening edge of the through hole 10.

In the first example embodiment, the collar portion 4 projects outward from the pin body 3 in directions along the opening edge of the through hole 18 of the heat sink 16, and is configured to have a size capable of locking the spring 20 attached to the pin body 3. In a state where the locking portions 14A and 14B of the pin body 3 are locked on the opening edge of the through hole 10, the spring 20 is arranged, in a compressed state, between the collar portion 4 and the opening edge of the through hole 18 of the heat sink 16. Thereby, the biasing force due to the spring 20 acts on the collar portion 4 and the opening edge of the through hole 18. Although this biasing force is force moving the pin body 3 in a direction (i.e., a direction of pulling the pin body 3 from the through holes 10 and 18) opposite to an insertion direction S, the locking portions 14A and 14B are pressed against and locked on the opening edge of the through hole 10, and then the pin body 3 is prevented from slipping off. The fastening part 1 is firmly attached to the circuit board 9 and the heat sink 16 by the force with which the locking portions 14A and 14B press the opening edge of the through hole 10, and the biasing force due to the spring 20.

The fastening part 1 according to the first example embodiment is configured as described above, and can obtain the advantageous effects described as follows. In other words, the locking portions 14A and 14B in the fastening part 1 protrude in the directions opposite to each other and project in the directions β that cross to the displacing directions α of the free ends of the elastic sections 12A and 12B. For this reason, for example, even when the elastic sections 12A and 12B elastically deform in the displacing direction α by an impact applied to the circuit board 9 due to falling or the like, the locking portions 14A and 14B can prevent a situation where a state of being locked on the opening edge of the through hole 10 of the circuit board 9 is dissolved. Thereby, a situation where the fastening part 1 falls off from the circuit board 9 can be prevented.

In the first example embodiment, the locking portions 14A and 14B are arranged to be displaced from each other in the directions β. For this reason, by an amount depending on this displaced amount, projecting amounts of the locking portions 14A and 14B can be increased. This is also an effective factor contributing to prevention of a situation where a state of locking the locking portions 14A and 14B on the opening edge of the through hole 10 of the circuit board 9 is dissolved.

The fastening part 1 according to the first example embodiment achieves, with a simple configuration, a configuration that can prevent a situation where the locked state of the locking portions 14A and 14B is dissolved, as described above.

Since a situation where the locked state of the locking portions 14A and 14B is dissolved can be prevented, the fastening part 1 even in the case of being formed of a resin material can achieve reliability of attachment at a level equivalent to that in the case of being formed of a metal. Thereby, forming the fastening part 1 of a resin material enables manufacture of the fastening part 1 at low cost without degradation in reliability.

In the first example embodiment, tapered faces are formed at the distal end portion 11 of the pin body 3. The tapered faces include the inclined portions that can receive pressing force (i.e., force elastically deforming the elastic sections 12A and 12B in such a way that the locking portions 14A and 14B are put in the aligned state) of the P direction while sliding on the opening edges of the through holes 10 and 18 by being inserted into the through holes 10 and 18. For this reason, although the locking portions 14A and 14B are formed at the distal end portion 11 of the pin body 3, the fastening part 1 can be easily attached by pushing the pin body 3 into the through holes 10 and 18 without using special tool or fittings, because of the tapered faces of the distal end portion 11.

Therefore, the fastening part 1 according to the first example embodiment can be easily attached to an attaching-target member, and can further achieve improvement in reliability of slip-off prevention and downsize the part.

### Second Example Embodiment

The following describes a second example embodiment according to the present invention.

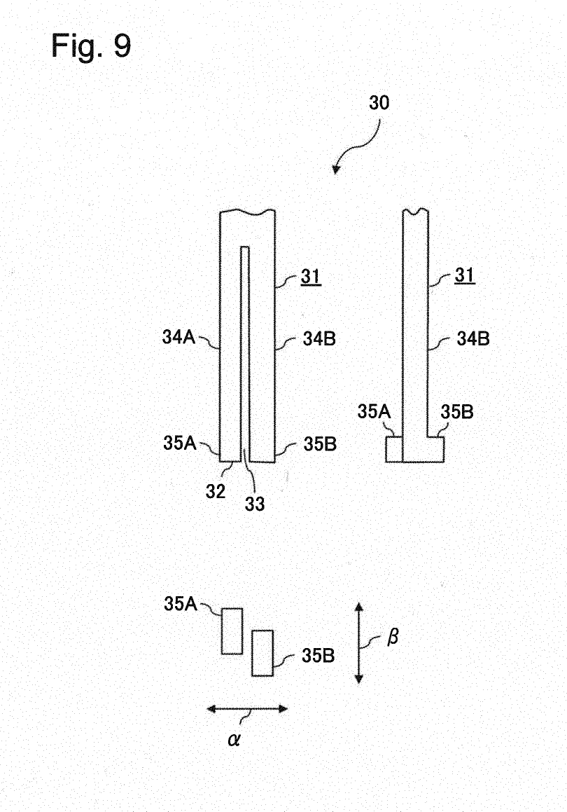

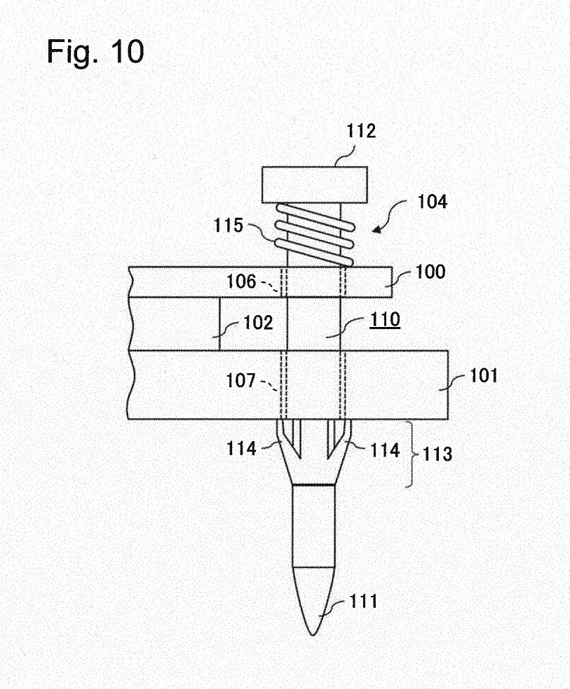

FIG. 9 is a three-plane view schematically illustrating a fastening part according to the second example embodiment.

The fastening part 30 according to this second example embodiment includes a pin body 31 that is inserted through a through hole formed in an attaching-target member. Similarly to the first example embodiment, formed in the pin body 31 is a gap 33 extending in a direction along a direction of insertion into the through hole, from a distal end portion 32 serving as a leading end at the time of being inserted into the through hole, and the gap 33 forms elastic sections 34A and 34B making a pair. The elastic sections 34A and 34B form free ends on distal end sides, and elastically deform. In the second example embodiment, the free ends of the elastic sections 34A and 34B are configured to be easily elastically displaced in the directions α illustrated in FIG. 9.

On the free end sides of the elastic sections 34A and 34B, locking portions 35A and 35B are formed to protrude. In other words, the locking portions 35A and 35B are configured to project, from the free-end sides of the elastic sections 34A and 34B, in the directions opposite to each other along the directions β crossing the displacing directions α of the free ends. The locking portions 35A and 35B are locked on the opening edge of the through hole through which the pin body 31 has been inserted, to thereby prevent the pin body 31 from slipping out of the through hole. Further, the locking portions 35A and 35B have shapes and sizes enabling insertion into the through hole by elastic deformation of the elastic sections 34A and 34B in the directions of dissolving the locked state of the locking portions 35A and 35B.

In the second example embodiment, the locking portions 35A and 35B project in the directions β crossing the displacing directions α of the free ends of the elastic sections 34A and 34B. For this reason, similarly to the first example embodiment, even when the elastic sections 34A and 34B bend and deform due to external force caused by falling or the like, a situation where the locked state of the locking portions 35A and 35B is dissolved can be prevented since the displacing direction is a direction different from the projecting directions of the locking portions 35A and 35B. Thereby, the fastening part 30 can improve reliability of the attachment. Further, because of the simple configuration, the fastening part 30 can easily achieve miniaturization, and can be easily attached to an attaching-target member.

### Other Example Embodiments

This invention is not limited to the first and second example embodiments, and can be variously configured to be embodied. For example, in the first example embodiment, shapes of the locking portions 14A and 14B are circular (fan-shapes), and in the second example embodiment, shapes of the locking portions 35A and 35B are quadrilateral. In contrast to this, the locking portions may be configured at least to project in the directions crossing the displacing directions of the free ends of the elastic sections and be capable of being locked on the opening edge of the through hole, and there is not a limitation on shapes of the locking portions.

In the first example embodiment and the second example embodiment, the projecting directions β of the locking portions 14A, 14B, 35A, and 35B are directions perpendicular to the displacing directions α of the free ends of the elastic sections. In contrast to this, projecting directions of the locking portions may cross the displacing directions α, and are not limited to the perpendicular directions. For example, although an opening shape of the through hole is often circular because of a manufacturing manner, there is also supposed a case where an opening shape of the through hole has a shape other than a circular shape. In such a case, by taking the opening shape of the through hole into account, the locking portions are designed in such a way that the projecting directions of the locking portions are appropriate directions crossing the displacing directions of the free ends of the elastic sections.

Further, in the first example embodiment, the distal end faces of the elastic sections 12A and 12B are formed into tapered faces. In contrast to this, for example, depending on a size of the fastening part, there is a case where the elastic sections can be elastically deformed easily, and in such a case, the distal end faces of the elastic sections do not need to be tapered faces.

Furthermore, a material forming the fastening part according to the present invention may be a resin material or a metal depending on requested price, strength, and the like, for example.

The present invention is described above by citing the above-described example embodiments as model examples. However, the present invention is not limited to the above-described example embodiments. In other words, various configurations that can be understood by those skilled in the art can be applied to the present invention within the scope of the present invention.

The present application claims priority based on Japanese patent application No. 2015-109942 filed on May 29, 2015, the entire disclosure of which is incorporated herein.

### REFERENCE SIGNS LIST

1, 30 Fastening part
3, 31 Pin body
4 Collar portion
12A, 12B, 34A, 34B Elastic section
14A, 14B, 35A, 35B Locking portion
10, 18 Through hole

What is claimed is:

1. A fastening part comprising
a pin body that is inserted through a through hole formed in an attaching-target member,
the pin body including:
elastically-deformable elastic sections that make a pair, each of the elastic sections extending along a direction of being inserted into the through hole and having a free end which is on side of distal end serving as leading end when being inserted into the through hole; and
locking portions that project from each side of free end of the elastic section and protrude in directions opposite to each other, projection directions of the locking portions being directions crossing to directions in which free ends of the elastic sections move due to elastic deformation of the elastic sections, wherein
the elastic sections elastically deform in such a way that the locking portions are displaced in the directions opposite to the projection directions, thereby the pin body is enabled to be inserted into the through hole, and the locking portions are locked on an opening edge of the through hole through which the pin body is inserted, thereby the pin body is prevented from slipping out of the through hole.

2. The fastening part according to claim 1, wherein each of the locking portions projects also in the direction in which the free end of the elastic section moves, and the elastic sections elastically deform in such a way that the locking portions are displaced in directions opposite to the projection directions, thereby the locking portions are enabled to be inserted into the through hole.

3. The fastening part according to claim 1, wherein distal end faces of the free ends of the elastic sections are formed into tapered faces inclined with respect to an insertion direction into the through hole, and the tapered faces include inclined portions that receive pressing force while sliding on the opening edge of the through hole when being inserted into the through hole, thereby guiding elastic deformation of the elastic sections in such a way that the elastic sections elastically deform and the locking portions are displaced to allow insertion into the through hole.

4. The fastening part according to claim 3, wherein the tapered faces are curved faces of conic-surface shape, and a conic-vertex position on the tapered faces is displaced from a center axis of the pin body.

5. A method for forming a fastening part, comprising:
forming, in a pin body that is inserted through a through hole formed in an attaching-target member, elastically-deformable elastic sections that make a pair, each of the elastic sections extending along a direction of being inserted into the through hole and having a free end which is on side of distal end serving as leading end when being inserted into the through hole; and
further forming, in the pin body, locking portions that project from each side of free end of the elastic section and protrude in directions opposite to each other, projection directions of the locking portions being directions crossing to directions in which free ends of the elastic sections move due to elastic deformation of the elastic sections.
